(19) United States
(12) Patent Application Publication
(10) Pub. No.: US 2018/0341729 A1
(43) Pub. Date: Nov. 29, 2018

(54) SYSTEMS AND METHODS FOR VESSEL FUEL UTILIZATION

(71) Applicant: CDI Marine Company, LLC, Philadelphia, PA (US)

(72) Inventors: Dina Kowalyshyn, Annapolis, MD (US); Ajit Anand, Laurel, MD (US); Manish Gupta, Laurel, MD (US); Michael Stanbro, Arnold, MD (US); Jonathan Nelson, Arnold, MD (US); Dale Danko, Osceola Mills, PA (US); Michael Elbert, Annapolis, MD (US)

(73) Assignee: CDI Marine Company, LLC, Philadelphia, PA (US)

(21) Appl. No.: 15/604,569

(22) Filed: May 24, 2017

(51) Int. Cl. G06F 17/50; B63J 99/00

(52) U.S. Cl. CPC G06F 17/5018; B63J 99/00; G06F 2217/16; B63J 2099/006; G06F 17/5095

(57) ABSTRACT

The systems and methods disclosed herein provide multiple solutions from maximizing efficiencies for propulsion and electrical plant equipment to reducing life cycle costs. Knowing how equipment is used/operated and how fuel is used to power equipment can increase awareness and can help to provide the best opportunity to maximize the technological gains in power generation. The systems and methods disclosed herein can provide such awareness by displaying current and projected fuel consumption attributable to specific factors encountered in operational conditions, including the environment, hull fouling, displacement and engineering plant modes. Systems and methods employ physics and quantitative based methodology that focus on assessing and quantifying fuel utilization impacts due to machinery employment, material condition disparities, abnormal configurations and excess usage.

### STATEMENT REGARDING FEDERALLY SPONSORED RESEARCH OR DEVELOPMENT

This application was made with U.S. government support under contract number N000178-04-D-4030 awarded by Naval Sea Systems Command, an organization within the United States Navy. The U.S. government, specifically the United States Navy, has certain rights in the application.

### FIELD OF USE

The present application relates to systems and methods for improving marine energy conservation and more specifically to determining projected fuel consumption attributable to specific factors in actual vessel operations.

### BACKGROUND

Maritime vessel fuel (e.g., distillate fuel marine, biofuels, gasoline, etc.) is used in vessel engineering systems. Energy usage of vessel engineering systems is directly affected by the propulsion and electric generating systems, which are inherently inefficient regarding energy usage due to design factors (e.g., heat loss in the cooling systems) that impact overall operational costs, as well as additional indirect factors, such as wind, water conditions, etc.

Vessel operations can compound these inefficiencies through the addition of a variety of different external factors that may not be adequately factored into the energy consumption considerations.

While systems and methods have been developed to apply technical solutions to reduce fuel consumption, such systems are often relatively simple, taking into account basic inputs such as engine efficiency, and it appears that no known systems or methods capture a large quantity of data from different sources or apply a significant number of factors that can affect energy consumption aboard a maritime vessel in order to determine overall efficiency. Moreover, these known systems do not appear capable of providing models for providing recommendations to vessel personnel to optimize fuel usage, nor do they appear capable of providing direct inputs into the vessel control systems to make such changes to improve energy consumption.

Therefore, there is a need for user-friendly applications that can quickly evaluate a broad number of different factors in order to produce one or more models of various different energy consumption models, so that vessel personnel can be provided suggestions for changing one or more vessel conditions such that fuel usage aboard the waterborne vessels can be improved in a real-time manner while the vessel is traveling across the water.

### SUMMARY

In some embodiments disclosed below, methods for determining energy consumption of a waterborne vessel during operational periods are provided. The methods can include determining a total resistance applied to the vessel; determining a total horsepower required for the vessel to overcome the total resistance; receiving a plurality of inputs corresponding to the condition of the vessel; determining propulsion-specific fuel consumption based on determined total resistance, determined total horsepower, and the received inputs; determining electric plant fuel consumption; calculating a total required fuel, the total required fuel which can include the sum of the required propulsion-specific fuel and required electric plant fuel; generating a set of projected propulsion-specific fuel consumption models; generating a set of projected electric plant fuel consumption models; and generating a fuel consumption optimization configuration that includes a projected propulsion-specific fuel consumption model of the set of projected propulsion-specific fuel consumption models and a projected electric plant fuel consumption model of the set of electric plant fuel consumption models.

In other embodiments, methods for projecting fuel consumption for a waterborne vessel are disclosed herein. The methods can include receiving, at a user device, a primary input of data corresponding to at least one of total resistance acting upon the vessel and electric plant fuel consumption; receiving, from memory, a first set of historical data corresponding to resistance acting upon the vessel; receiving, from memory, a second set of historical data corresponding to electric plant fuel consumption; determining a propulsion-specific fuel consumption corresponding to the total resistance, in which the total resistance can include the input of data and the first set of historical data; and calculating, in response to determining the total horsepower, a total fuel consumption based on: a total electric plant fuel consumption based on the input of data and the second set of historical data; and the propulsion-specific fuel consumption.

In other embodiments, devices are provided. The devices can include storage; memory; an input interface operable to receive a plurality of inputs corresponding to a condition of a vessel; an output interface; communications circuitry; and control circuitry operable to: determine a total resistance applied to a vessel; determine a total horsepower required for the vessel to overcome the total resistance; determine propulsion-specific fuel consumption based on the determined total resistance, determined total horsepower required, and the received condition inputs; determine electric plant fuel consumption; calculate a total required fuel based on the sum of the propulsion-specific fuel consumption and electric plant fuel consumption; generate a plurality of projected propulsion-specific fuel consumption models; generate a plurality of projected electric plant fuel consumption models; and generate a fuel consumption optimizing configuration, including: a projected propulsion-specific fuel consumption model of the plurality of projected propulsion-specific fuel consumption models; and a projected electric plant fuel consumption model of the plurality of electric plant fuel consumption models.

In still other embodiments, non-transitory computer readable media are provided. The medium can contain instructions that, when executed by at least one processor of a computing device, cause the computing device to: determine a total resistance applied to a vessel; determine a total horsepower required for the vessel to overcome the total resistance; receive a plurality of inputs corresponding to a condition of the vessel; determine propulsion-specific fuel consumption based on total resistance, total horsepower required, and the received inputs; determine electric plant fuel consumption; calculate a total required fuel, the total required fuel comprising the sum of the required propulsion-specific fuel and required electric plant fuel; generate a set of projected propulsion-specific fuel consumption models; generate a set of projected electric plant fuel consumption models; and generate a fuel optimizing configuration including an optimal projected propulsion-specific fuel consumption model of the set of projected propulsion-specific fuel consumption models and an optimal projected electric plant fuel consumption model of the set of electric plant fuel consumption models.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1A is an illustration of a waterborne vessel in accordance with various embodiments;

FIG. 1B is an illustrative diagram of a process for determining energy consumption of a waterborne vessel during an operational period in accordance with various embodiments;

FIG. 2 is an illustrative diagram of a process for determining the total resistance applied to a vessel in accordance with various embodiments;

FIG. 3 is a schematic diagram of various sources of data that can be input into a module in accordance with various embodiments;

FIG. 4 is an illustrative schematic diagram of sample user interface for inputting values into a module for calculating fuel consumption in accordance with various embodiments;

FIG. 5 is an illustrative flowchart of a process for prioritizing data sources in accordance with various embodiments;

FIG. 6 is an illustrative graphical user interface that can be utilized to display exemplary summary reports in accordance with various embodiments;

FIG. 7 is an illustrative graphical user interface that can be utilized to display sets of models in accordance with various embodiments;

FIG. 8 is an illustrative graphical user interface of a model in accordance with various embodiments; and

FIG. 9 is a block diagram of an illustrative user device in accordance with various embodiments.

### DETAILED DESCRIPTION OF THE DRAWINGS

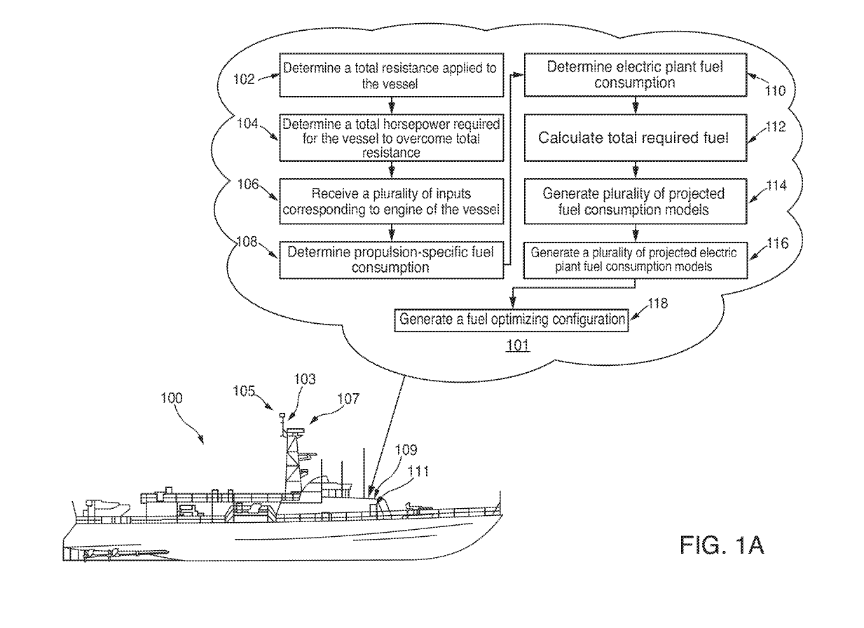

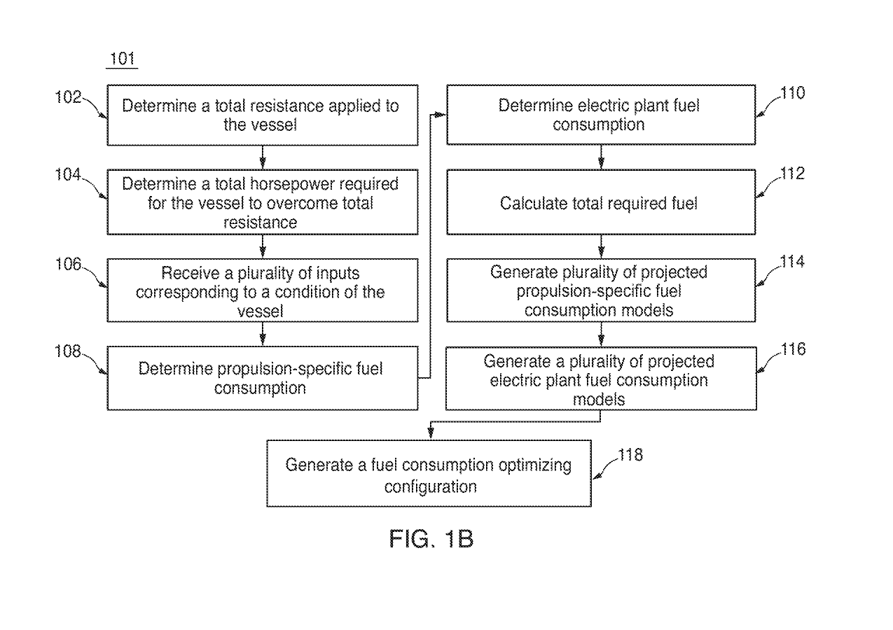

FIG. 1A is an illustration of a waterborne vessel 100 in accordance with various embodiments. Vessel 100 can include a transmitter 103, a receiver 105, a sensor 107, a center console 109, which can include equipment capable of performing a process to evaluate energy consumption and provide corrective recommendations (such as process 101 that is illustrated as a flow diagram in FIG. 1A), and an HVAC unit 111.

Vessel 100 can include transmitter 103 for transmitting information to a network, other vessels, server(s), or another intended recipient of data. In some embodiments, transmitter 103 can send information to a receiver located in center console 109, in which a user can be operating one or more applications that include software modules. The data received from transmitter 103 can be used to make any number of calculations useful in helping to determine fuel consumption information for vessel 100. For example, in some embodiments, transmitter 103 may be used to send data obtained by sensor 107 (see below for more details on sensor 107 and the types of data sensor 107 can be used to obtain) to center console 109. In other embodiments, transmitter 103 may be used to send data obtained by sensor 107 to one or more networks that can compile data from vessel 100 and other vessels communicating with the network in order to determine correlations amongst multiple vessels under given circumstances (e.g., by generating data curves that model movement of multiple vessels), to make calculations that require variables from vessel 100 as well as other vessels in the network, or to perform any other necessary tasks using the data received from transmitter 103.

In some embodiments, receiver 105 may be capable of communicating with a variety of transmitting devices. Receiver 105 can be capable of receiving data from a plurality of sources, including, but not limited to an Integrated Condition Assessment System (“ICAS”) or a Machinery Control System (“MCS”). Receiver 105 may be electrically coupled to transmitter 103, whereby the data received at receiver 105 may be transmitted to a receiver in center console 109.

In some embodiments, sensor 107 may be used to obtain a variety of different types of data for use as described in more detail below. For instance, in some embodiments, sensor 107 can be used to determine wind speed, direction, and outside air temperature (in which case “sensor 107” may include a variety of individual different sensors). In other embodiments, sensor 107 can be located on an exterior surface of the hull of vessel 100 such that it is submerged when the vessel is in the water, in which case sensor 107 can be used to obtain data corresponding to water in the surrounding environment of vessel 100. In some embodiments, sensor 107 can be electrically coupled to transmitter 103, whereby data recorded by sensor 107 may be transmitted to a receiver in center console 109.

In some embodiments, center console 109 can include one or more processing systems that can include one or more modules that can be utilized to determine configurations for obtaining improved fuel consumption on the vessel. For instance, center console 109 may include equipment for executing process 101. Center console 109 may also include a computing device with one or more processors that can perform calculations to determine propulsion-specific fuel consumption and electric plant fuel consumption on the vessel. In some embodiments, center console 109 can include a receiver, a transmitter, and other devices that can be utilized to perform the methods described herein. In some embodiments, a user can activate one or more modules located in computing device(s) located in center console 109. The modules can receive data from transmitter 105 that was received by receiver 103 and/or obtained by sensor 107, and/or other data from a variety of other sources. Center console 109 may also include a display 914 (see below for more detail), such that when the processor(s) calculate propulsion-specific fuel consumption and electric plant fuel consumption by the several systems and equipment installed on vessel 100, and generate one or more models to illustrate various available configurations to optimize fuel consumption by vessel 100, those configurations can be provided to the user on display 914.

HVAC unit 111 is an illustrative example of a fuel-consuming piece of equipment. In some embodiments, HVAC unit 111 controls a major air conditioning system on vessel 100. In some embodiments, HVAC unit 111 can include various sensors and transmitters to obtain and send information to system(s) running on center console 109 and/or network(s) or other recipient(s) of information outside of vessel 100. The data obtained by HVAC unit 111 and other electricity-consuming systems and equipment will be used to calculate electric plant fuel consumption with respect to vessel 100.

FIG. 1B is an illustrative diagram of process 101 (shown and briefly described in FIG. 1A) for determining energy consumption of a waterborne vessel during travel in accordance with various embodiments. In some embodiments, process 101 can be performed by system(s) installed on vessel 100, such as those described above in center console 109 in connection with FIG. 1A.

At step 102, a total resistance applied to the vessel can be determined. Total resistance can be based on an accumulation of a variety of factors that affect what a vessel must overcome in order to move through the water. The more resistance that is overcome, the easier it is for the vessel to travel through the water and the less energy that is required to make such travel occur. Accordingly, total resistance can impact a vessel's ability to travel through a body of water and the vessel's propulsion-specific fuel consumption. For each of the factors considered, an associated resistance value can be determined. The determined resistance values can then be utilized to determine the horsepower needed to overcome at least part of the resistance. The determined horsepower value for each factor (as will be further explained in greater detail below) can be correlated to a certain amount of projected fuel consumption. The factors can include, but are not limited to, various hull resistance factors, environmental related resistance factors, and vessel operations related factors. The total resistance may be calculated for a projected fuel consumption, or may be calculated for real-time fuel consumption, or may be calculated for past fuel consumption, or combinations thereof. In some embodiments, projected total fuel consumption may be desirable prior to beginning a mission. In some embodiments, once a projected fuel consumption is determined, a predetermined route for mission planning may be generated. In some embodiments, when determining real time fuel consumption, deviations from a planned course may be dictated by various factors, including but not limited to changing sea currents, prevailing winds/seas, water depth, obstructions, or a variety of other factors. Thus, real-time calculations may vary greatly from projected calculations, and accordingly, the systems and methods disclosed herein could be utilized to create alternative courses, and to determine and record such deviations for considerations in future projections.

At step 104, a total horsepower required for the vessel to overcome total resistance can be determined. With the resistance components established in step 102, corresponding horsepower components can be determined. The horsepower that can be used to overcome, for example, aerodynamic resistance, can be a function of relative wind speed, aerodynamic resistance, and/or propulsive efficiency. The horsepower that can be used to overcome calm water resistance, on the other hand, can be a function of the vessel's speed through water, calm water resistance, and/or propulsive efficiency. The horsepower that can be used to overcome the added resistance due to, for example, waves can be a function of the vessel's speed through water, added resistance due to waves, and/or propulsive efficiency. The total horsepower required for propulsion through the water can be determined, for example, by summing the three horsepower variables described above.

At step 106, a plurality of inputs corresponding to the condition of an engine of the vessel can be received. For instance, in some embodiments, it may be helpful to account for compressor fouling and wear that can occur through normal operations. Accordingly, a degradation factor may be applied to adjust power output, which can effectively increase the power that the gas turbine in the engines produces. This in turn can impact specific fuel consumption by association, typically increasing specific fuel consumption on a smaller magnitude than the associated increase in power required. For example, a five (5) percent degradation would approximately account for a two (2) to three (3) percent increase in specific fuel consumption. The degradation may be provided as an input variable with a specific input range. For instance, an input range may be provided having values ranging from 0.75 to 1.0, where a value of 1.0 is “new” with no wear, fouling, or losses. A default value may be provided at a value of 0.95, which corresponds to a five (5) percent degradation. Prior to calculating specific fuel consumption, the calculated horsepower required (as described in step 106) can be divided by the degradation factor. This can effectively increase the power that the gas turbine should produce to account for compressor fouling, wear, and inlet and outlet losses.

In some embodiments, it may be helpful to calculate specific fuel consumption individually for port and starboard sides of the vessel because the port and starboard propellers may be set to drive at different speeds, such as in Split Plant versus Full Plant operating modes. This can result in different engines running different power turbine speeds between the port and starboard sides of the vessel. The difference can be determined by initially determining needed horsepower for each propeller shaft individually. By determining horsepower per propeller shaft, the accuracy of the estimation of fuel required can be increased because of the ability of the systems and methods described herein to account for instances where the propeller shafts are rotating at different rates, such as when a vessel is making a turn. The calculation of port and starboard horsepower can therefore be dependent on the plant operating mode.

Once individual port and starboard horsepower is determined, the port and starboard specific fuel consumption may be calculated and the estimated propulsion-specific fuel needed can be determined based on the determined specific fuel consumption values.

At step 108, a total required propulsion-specific fuel can be determined. Total required propulsion-specific fuel can be first determined by calculating propulsion-specific fuel consumption. Once the total horsepower needed has been determined, the propulsion-specific fuel consumption can then be estimated as a function of, for example, power turbine speed, total horsepower required, gas turbine degradation factor, specific fuel consumption correction factor, intake air temperature, number of turbines operating, and/or the fuel's lower heating value. The calculation of specific fuel consumption at a given time can be independent of vessel speed, but is generally inherently dependent on plant operating mode. For example, since Split Plant and Full Power operating modes may have propellers driving at different speeds, specific fuel consumption can be determined for each turbine and for each side of the vessel, port and starboard.

In some embodiments, an intake air temperature can be set by default to 59 degrees Fahrenheit, and a specific fuel consumption correction factor can be added that can be dependent on power turbine speed. However, in some embodiments, intake air temperature values may be retrieved from databases, devices, and applications installed on the vessel, as well as from user inputs. Intake air consumption and specific fuel consumption are generally directly proportional to one another. As such, if the intake air temperature increases above 59 degrees Fahrenheit, specific fuel consumption also likely increases, and if the intake air temperature decreases below 59 degrees Fahrenheit, specific fuel consumption also likely decreases. In some embodiments, intake air temperature can be received from a system such as the ICAS system described above. In other embodiments, intake air temperature may, for example, be input by a user. In such embodiments, determinations may be made to correct for fuels having a lower heating value, such as below 18,400 British thermal units per pound. These variables may then be used to determine specific fuel consumption.

Required propulsion-specific fuel can then be determined as a function of total horsepower needed, specific fuel consumption, number of gas turbines operating, and/or fuel density. In some embodiments, fuel density can be calculated from the energy content and lower heating value of the fuel. For instance, the energy content of F-76 Military Diesel fuel is 128,800 British thermal units per gallon with a lower heating value of 18,400 British thermal units per pound. Dividing energy content by lower heating value gives a fuel density of seven (7) pounds per gallon. In other embodiments, a user may simply input the fuel density, if known, for the fuel being used.

In some embodiments, a component-wise fuel consumption can be determined in order to later establish the most fuel efficient configurations for a given vessel. This component-wise fuel consumption, referred to herein as component contribution, may present the contribution of each component that is used to determine the overall required propulsion-specific fuel. The component contribution can be directly proportional to the component-wise contribution of the total power required. These fractional fuel components can contain known and assumed variables that impact the required propulsion-specific fuel. In some embodiments, unknown variables can be accounted for by modeling the difference between the known variables of the projected propulsion-specific fuel required for a mission and the actual consumed propulsion-specific fuel required for the mission. This propulsion-specific fuel difference can be used to represent and/or ascertain variables that may not be able to be fully captured using projections, such as real-time changes in environmental variables, maneuvering, the hydrodynamic effect of current, and a variety of other factors.

At step 110, an electric plant fuel consumption can be determined. Electric plant fuel consumption can be a function of the electric power demand, gas turbine generator specific fuel consumption, and/or the number of gas turbine generators operating. In some embodiments, electric plant fuel can be determined by receiving data from several sources, including but not limited to, machinery control systems, equipment and system specifications, informal performance assessment reports (“IPAR”), formulated data curves, and/or calculations based off of other data received. This data may relate to system and equipment loads throughout the entire vessel. Large amounts of fuel consumption often result from electrical demands of specific systems and equipment, losses or excessive power demand due to degraded machinery and material conditions, and/or environmental conditions, all of which may influence the electrical load placed on a vessel's generator(s).

In some embodiments, factors relating to machinery utilization can be considered in the determination of electric plant fuel consumption. Machinery utilization can apply to operations of a mechanical item or system, including its frequency of use, runtime, loading, external operating conditions, standard operating procedures, and set points, among other things. For instance, an air conditioning plant can operate to maintain a range of temperatures in a space, and the range may be fixed (e.g., requiring a sustained rate of fuel consumption), or it may be user dependent (e.g., requiring varying rates of fuel consumption at any given time). Optimal machinery utilization can be desirable since equipment operating at near-design specification can result in more efficient loading and fuel consumption for its load. Conversely, non-optimal utilization can produce inefficient loading and excessive fuel consumption. Accordingly, in some embodiments, determining electric plant fuel consumption can include determining fuel consumption for several systems and equipment installed on a vessel in order to determine which systems and equipment are operating at higher efficiency and which are not. Further, in other embodiments, determining individualized fuel consumption regarding specific systems and equipment can allow for the determination of optimal configurations for fuel consumption, in which inefficient systems and equipment may be turned off or reduced in power, while more efficient systems and equipment may remain in use at full power. Similarly, systems and equipment that do not need to be in use at certain times may change configurations from requiring a fixed rate of fuel consumption to a more variable rate of fuel consumption. Such determinations may also be utilized to schedule and perform maintenance on such systems to improve overall fuel efficiency over time.

In some embodiments, factors relating to material condition can be considered in the determination of electric plant fuel consumption. Material condition can be applicable to the physical condition of a mechanical item or system and related components, and in particular, to parts critical to performance and efficiency. Examples can include, but are not limited to pump filters, control system temperature sensors, fan blade cleanliness, refrigerant charge, and/or lube oil levels. Degraded material conditions can often be manifested in reduced performance and/or excessive loading, with potential to increase the fuel consumption needed to achieve a desired function. Accordingly, in some embodiments, fuel consumption may be monitored on an hourly, daily, weekly, monthly, or even yearly basis to establish a mean level of fuel consumption. When it is determined that fuel consumption levels are varying beyond a given or established standard or otherwise predetermined acceptable deviation, the corresponding machinery operating at these levels may be flagged for maintenance and/or replacement. In other embodiments, optimal configurations may be determined using this information, for example, such that defective equipment may be deactivated during operations when more efficient fuel consumption is desired (for example, when more efficient fuel consumption may extend the effective range of the vessel).

At step 112, total fuel needed can be determined. The total fuel needed can be determined by, for example, summing the amount of propulsion-specific fuel needed with the amount of electric plant fuel needed to maintain the desired operations.

At step 114, a plurality of propulsion-specific fuel consumption models can be generated. The models can be based on individual assessments of systems and equipment installed on the vessel, determining which systems and equipment are absolutely necessary for the operation of the vessel, and/or which systems and equipment may be turned off or reduced in power. In some embodiments, models can include assigning power usage and fuel consumption configurations to various systems and equipment in accordance with one or more created schedules. In other embodiments, models generated prior to a mission may select certain machinery or system components that should be replaced prior to beginning the mission, if more efficient fuel operations are desired. In other embodiments, at the end of a mission or voyage, models of vessel operations may be compared to the actual results of the mission or voyage to determine variances that can be used to further improve ongoing operations. Accordingly, as more information is gathered with respect to certain geographical areas, environmental conditions, material conditions, etc., some generated models may be compared to similar previously generated models relating to similar past missions and voyages and may be ranked accordingly.

At step 116, a plurality of electric plant fuel consumption models can be generated. The models can be based on individual assessments of systems and equipment installed on the vessel, determining which systems and equipment are absolutely necessary for the operation of the vessel, and/or which systems and equipment may be turned off or reduced in power. In some embodiments, models can include assigning power usage and fuel consumption to various systems and equipment in accordance with one or more created schedules. In other embodiments, models generated prior to a mission may be used to determine that certain machinery or systems components should be replaced prior to beginning the mission for more efficient operations. In other embodiments, at the end of a mission or voyage, models may be compared to the actual results of the mission or voyage for future reference and in order to determine variances that can be used to further improve ongoing operations. Accordingly, as more information is gathered with respect to certain geographical areas, environmental conditions, material conditions, etc., some generated models may be compared to similar previously generated models relating to similar past missions and voyages and may be ranked accordingly. In some embodiments, if a generated model compares unfavorably to similar models for similar missions or voyages of the past, that generated model may be automatically eliminated, prompting the generation of a new model.

At step 118, a fuel optimizing configuration can be generated. In some embodiments, the fuel optimizing configuration can be based on a combination of a propulsion-specific fuel consumption model and an electric plant fuel consumption model. In some embodiments, a user interface may be generated that first provides the various propulsion-specific fuel consumption models, and after a user selects a propulsion-specific fuel consumption model that most adequately suits that user's expected needs, the user interface may then provide various electric plant fuel consumption models, and after a user then selects an electric plant fuel consumption model that most adequately suits that user's needs, a combination of the two models can be used to generate a fuel optimizing configuration. In other embodiments, the user interface can first provide electric plant fuel models to be selected by a user, and then can provide propulsion-specific fuel consumption models that can be combined with the selected electric plant fuel model. Such embodiments could be used to allow a user to prioritize the vessel's resources throughout a vessel's operations.

In some embodiments, an additional step may involve automatically configuring the vessel to the fuel optimizing configuration. In some embodiments, yet another step involves continually monitoring propulsion-specific fuel consumption and electric plant fuel consumption and automatically adjusting vessel configurations in order to ensure that the best fuel consumption configurations are utilized.

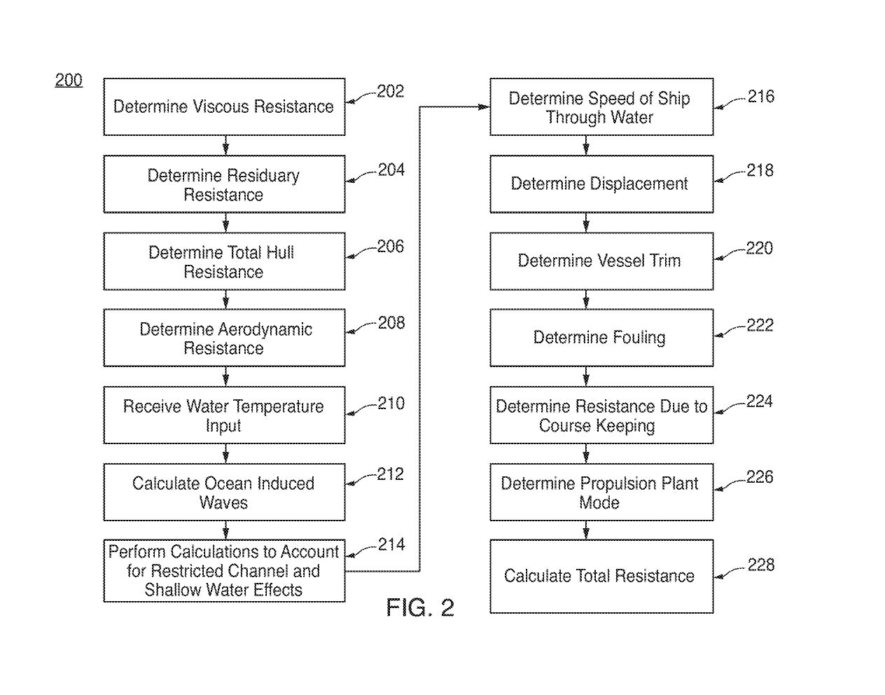

FIG. 2 is an illustrative diagram for a process 200 for determining the total resistance applied to a vessel, in accordance with various embodiments of the disclosure.

At step 202, a viscous (frictional) resistance can be determined. The viscous resistance can be a function of a total hydrodynamic resistance coefficient, sea water density, wetted surface area, the vessel's speed through water, displacement, and fouling correction factor. In more simplified terms, the viscous resistance applied to a vessel can be created from several sources. Such sources can include, but are not limited to travel through a body of water, skin friction, forces related to separation of water from the hull, and eddy-making resistance. In a non-limiting embodiment, the viscous component of vessel resistance can be obtained from formulations known in the art.

At step 204, a residuary (wave-making) resistance can be determined. This resistance can be a function of warm water resistance, the vessel's speed through water, the vessel's heading, wave direction, significant wave height, and oblique wave correction factor. The residuary resistance can be a result of the passage of a vessel through a body of water, causing the vessel to create a wave in the water, which adds resistance. This resistance can be captured as part of calm water towing tank model resistance. Calm water towing tank model resistance is derived from model tests used to capture all the components of resistance. The model tests use viscous resistance as a function of wetted surface of the model, so the rest of the resistance is assumed to be “residuary” resistance, which includes wave-making during testing. The results are then used directly as a full-scale coefficient for use in vessel performance calculations.

At step 206, the total hull resistance can be determined. A correlation allowance can be used to account for the uncertainties in the formulation methods for full scale performance from model test data. Correlation allowance is the factor that aligns the model test answer to full-scale performance. Correlation allowance can account for small errors in the tests and assumptions made. This value can be assigned after full-scale trials to reconcile the results. Repeated testing and trials can allow data to be collected multiple times for involving, for instance, models in a tank vessels in a sea. The result of this data can be a reported correlation allowance.

At step 208, aerodynamic resistance can be determined. Aerodynamic resistance can be a function of a heading coefficient, a vessel's aerodynamic resistance coefficient, air density, frontal surface area, a vessel's speed through water, a vessel's heading, wind speed, true wind direction, speed of drift, and direction of set. Air resistance coefficients can be estimates or determined from testing (model and full scale). Many ships today can use calculations to determine the air resistance coefficients. The majority of aerodynamic resistance may be generated by a vessel operating at a given speed through still air, with a smaller percentage of resistance contributed from environmental wind. When averaging over a longer time period, including but not limited to days, weeks, and months, it may be useful to simply negate wind contribution. Conversely, for shorter time periods, including but not limited to minutes and hours, the resistance contribution from wind may be significant. As persons of ordinary skill in the art will realize, vessel standardization trials can take the average of two or more reciprocal runs at a given speed to permit the isolation of still air contributions regardless of wind direction (presuming a steady wind direction). Air resistance can thus be a function of the surface area of the vessel normal to the direction of travel. In various embodiments, the formula of air resistance from Principles of Naval Architecture may be employed to include the effects of wind. A vessel's aerodynamic resistance coefficient changes as the relative wind direction changes. To account for non-zero headings, a heading coefficient can be multiplied by the vessel's aerodynamic resistance coefficient where the heading coefficient can be calculated based on the relative wind direction. The relative wind speed and direction may be calculated by summation of the vessel's speed and direction through water with the true wind speed and the true wind direction in reference to the vessel's centerline, and current speed and direction.

In another embodiment, current (e.g., set and drift) may be inputted by a user to determine relative wind speed. As mentioned above, relative wind speed can be a function of the vessel speed and direction through water, current speed and direction, and true wind speed and direction. Also as noted above, relative wind speed can be used to calculate aerodynamic resistance. Accordingly, set and drift can be useful in some embodiments in both pre-voyage planning and post-mission fuel utilization analysis. For instance, set and drift may be used to determine the total distance a vessel travels over ground on a per-time increment basis.

At step 210, an input relating to water temperature can be received. This input can be received from a machinery control system, sensors, storage, and other sources of data located on a vessel. The temperature of the body of water in which the vessel travels can have an effect on engine cooling and fuel combustion efficiency. Water temperature can affect water density, which in turn can impact viscous resistance.

At step 212, ocean induced waves can be calculated. The cause of resistance due to ocean induced waves can be the oscillation of the vessel in heave and pitch due to ocean waves, which causes an increase in the energy radiating from the vessel and hence added resistance. The added resistance can be proportional to the square of the wave height, and can be dependent upon the vessel's response to the wave spectrum. This resistance can be accounted for as an added percent effective power based on sea state and the speed of the vessel through water.

In some embodiments, additional calculations may be included to account for the effect of a vessel traveling at an oblique angle to the prevailing sea. This can be a complex estimation that can be dependent on wave height, wave period, vessel speed and bearing to the waves, and frequency of wave encounter as a function of vessel speed. The added resistance of a vessel in such waves can include two parts: 1) motion induced resistance caused by heave and pitch of the vessel; and 2) reflection induced resistance, which can be a function of the bow shape. Accordingly, in various embodiments, wave height, wave period, vessel speed, and heading can be included in the calculations.

In some embodiments, various approximations are suitable for determinations described herein. In some embodiments, the best approximation may come from the available model test data (e.g., previously constructed data curves) and not from empirical approximations gathered from, for instance, mission data.

In some embodiments, resistance due to operating in waves may be determined as an added percent effective power based on sea state and vessel speed through water. Added percent effective power is greater power that can be required to move through ocean waves than can be required to move through calm water. Persons of ordinary skill in the art will appreciate that greater power can be required to move through ocean waves than can be required to move through calm water. Also, there could be multiple physical factors that might cause such an increased power requirement. Such factors may include, but would not be limited to higher wetted hull surface area as the vessel moves up and down in the waves, loss of forward momentum from plunging into a wave (that can then be recovered for a constant speed), and frequent rudder changes (e.g., manual changes or changes made via rudder roll stabilization) that can increase drag to keep the vessel on course or in safe condition.

At step 214, calculations can be performed to account for restricted channel and shallow water effects. In shallow water, the flow of water over the bottom of a vessel's hull can be restricted, causing that water near the hull to speed up. Faster moving water can increase resistance applied to the hull while decreasing the pressure under the hull, causing the vessel to “squat,” which can increase the wetted surface area and increase both frictional and wave-making resistance. Similarly, in a restricted channel, confined waters can produce this same effect between a side of the vessel and the canal wall.

The vessel's wake produced in shallow water also can be larger than those same waves produced in deep water at the same speed. As a result, the energy required to produce the wake may increase (i.e., wave-making resistance can increase in shallow water).

At step 216, the speed of the vessel through water can be obtained. Naturally, the speed of the vessel through water can be important for various reasons. Among those reasons is that at some speeds, the crests and troughs of the bow and stern waves can reinforce each other producing higher overall wake wave heights and a subsequent increase in resistance. As the length of the bow wave approaches the length of the vessel, the wave-making component of resistance may begin to increase rapidly. The vessel may have been designed to have the power to travel in this region and beyond, but mission planning and operator awareness of the impact of traveling near this speed will affect fuel consumption. In general, it may be advantageous for the vessel to transit at certain speeds, and to configure its propulsion plant to operate at its most efficient modes for the required speed and power demands. Once these configurations are determined for a vessel, these conditions can be used to create the efficient environment for the vessel to achieve reductions in fuel consumption.

At step 218, a vessel's displacement can be determined. A vessel's displacement can be a function of its payload, fuel load, and lightship weight. Greater displacement may cause greater wetted surface area on the hull, leading to greater hydrodynamic resistance. This accordingly can cause an increased need for horsepower for a steady speed, and ultimately greater fuel consumption. The hull shape can be important with respect to wave-making and how the water flows around the hull at different waterlines. These characteristics may be carefully examined and the values of resistance determined in the model testing stage where it might be advantageous to test at three or four different displacements, then possibly verify the results at full scale trials if the vessel's mission calls for it to operate over a large range of loading conditions. A naval combatant's operating displacement range may be narrower when compared to that of, for example, an auxiliary tanker, but these conditions might be necessary to project fuel consumption. Displacement can be largely mission dependent. Thus, a simple percentage correction can be made to relate small displacement changes to relative increases in horsepower in calm water. This correction might be +/−3.5 percent per +/−100 long tons change in displacement.

At step 220, vessel trim can be determined. For each displacement and draft combination, at each speed, there can be a fuel consumption optimizing trim that relates to lowest resistance. Persons of ordinary skill in the art will recognize that it can be very helpful to ballast a vessel to take advantage of these various combinations. Ballasting can include taking on water in tanks, releasing water from tanks, and transferring fuel between tanks in different locations in the vessel to affect the final trim of the vessel. For vessels with large transom sterns and bulbous bows, the power requirements for the best and worst trim may differ by more than 10 percent.

At step 222, the fouling condition of the hull, rudders, and propellers can be determined. Any increase in hull roughness can increase hull frictional resistance or vessel drag, resulting in an additional power requirement with increased fuel consumption and cost to maintain vessel speed. As known to persons having ordinary skill in the art, vessels generally get rougher over time due to mechanical damage from anchor chains, grounding, cracking, detachment, and corrosion of applied surface coatings, among other things. Hull roughness includes biological fouling or damage to the coating system. The increase in roughness can differ depending on which antifouling coating type is applied to the hull. In some circumstances, the best and most viable approach to reducing any fouling resistance can be to clean the vessel regularly, as well as before sailing if the vessel has been stationary for a long enough period of time to have become fouled. Because this is not always feasible, some important factors considered in various embodiments of the present disclosure are: 1) time since last hull cleaning, painting, or coating; and 2) hull coating and condition, in the form of fouling rating. Since fouling can be fairly subjective, this variable can be quantified and input into a module by a user, and it can therefore be up to the user's discretion to select a realistic fouling type that corresponds to the vessel's level of hull fouling.

At step 224, resistance due to course keeping can be calculated. Every turn of the vessel's rudder can create a lift and drag force on the rudder that can be exerted to change the direction of the vessel. This change of direction can be an increase in drag over the calm water straight-line resistance from the towing tank. Accordingly, the added resistance due to course keeping can be the sum of the drag component of the rudder and the drag component of the vessel's moment through the water. During vessel design, these mathematical descriptions can be determined as part of the maneuvering model tests and confirmed during sea trials.

At step 226, propulsion plant mode can be determined. Fuel consumption by the propulsion turbines for any given vessel speed depends on the plant mode, material condition, and ambient atmospheric conditions. In theory (although the present disclosure is not bound by theory) for a specific engine, specific fuel consumption can be based on the torque delivered to the output shaft with respect to the fuel mass flow delivered to the engine. The respective propulsion turbine fuel mass flow rates can be extracted from any suitable source of data available for the vessel. However, for the formulated ideal consumption, the projected shaft horsepower is helpful to determine the projected fuel consumption. The effective horsepower can be translated to delivered horsepower by accounting for the losses in efficiency between the vessel's propeller shaft and the thrust produced by one or more propellers. Delivered Horsepower may be the power available at the output side of the engine (i.e. at crankshaft flange of the engine which connects it with the flywheel and rest of the intermediate shaft). Effective Horsepower may be the power available at the shaft after accounting for frictional and mechanical losses (e.g., gearbox, shaft bearing losses, etc.). The shaft horsepower to produce delivered horsepower with respect to the propeller can be determined by accounting for any losses in the transmission from the shaft at the gear box to the propeller outside the hull.

At step 228, each factor can be combined to calculate the total resistance applied to the vessel. This can be achieved by the summation of all of the values determined at the preceding steps.

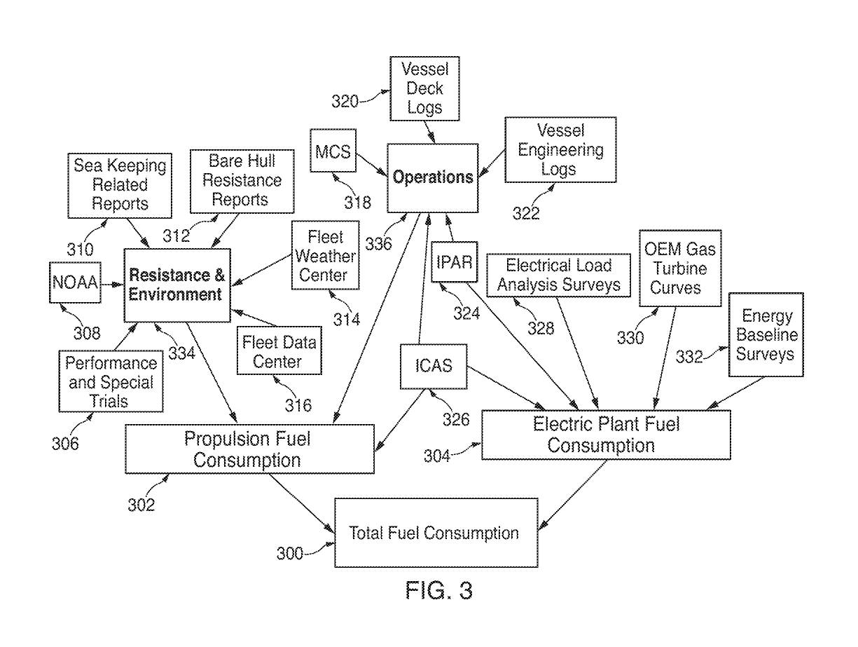

FIG. 3 is a schematic diagram of various sources of data inputted into a module in accordance with various embodiments of the disclosure. In some embodiments, two major factors in determining total fuel consumption 300 can be propulsion-specific fuel consumption 302 and electric plant fuel consumption 304. Propulsion-specific fuel consumption 302 can be based on resistance and environment 334 and vessel operations 336. The various sources for all of these factors include, but are not limited to performance and special trials 306, real-time and historical data recorded by the National Oceanic and Atmospheric Association 308 (“NOAA”), sea keeping related reports 310, bare hull resistance reports 312, data from the Fleet Weather Center 314, data from the Fleet Data Center 316, a Machinery Control System 318 (“MCS”), vessel deck logs 320, vessel engineering logs 322, IPAR 324, ICAS 326, electrical load analysis surveys 328, original equipment manufacturer (“OEM”) gas turbine curves 330, and various other energy baseline surveys 332.

Propulsion-specific fuel consumption 302 can be calculated from data pulled from a variety of sources. For instance, in some embodiments, equipment parameters are obtained from ICAS 326, which was developed to support condition-based maintenance of major hull, mechanical, and electrical systems through the collection and trending of operating parameters. The configuration data set from ICAS 326, which is built from and thus includes a vast naval engineering knowledge base, varies based on the vessel system configurations. ICAS 326 can provide maintenance trending data on various systems and equipment, including but not limited to, main propulsion, reduction gear, line shaft bearings, controllable pitch propeller, vessel service gas turbine generators, fuel oil service, main propulsion lube oil, lube oil fill, transfer, and purification, air conditioning, refrigeration, distilling plants, auxiliary boilers, firemains, seawater pumps, fuel oil fill and transfer, high-pressure compressed air, and low-pressure compressed air. In some embodiments, ICAS 326 data can be retrieved to operate at the lowest functional levels of granularity, such as the observation period or time step. Accordingly, ICAS 326 equipment data may be retrieved in time intervals (e.g. 10 minutes, 15 minutes, 20 minutes, 3 hours, one day, etc.), allowing the analysis of multiple months of data in a matter of minutes.

In some embodiments, Performance and Special Trials 306 reports may be utilized for a variety of calculations, such as calculations relating to plant modes and propeller shaft speeds. Bare hull resistance reports 312 and sea keeping related reports 310 can also be used to formulate vessel power and total resistance and environment 334 related factors.

In some embodiments, certain environmental data may be received as user inputs, or as variables from available historical environmental data from NOAA 308, Fleet Data Center 314, or other sources. Historical environmental data can be useful in the generation of projected fuel consumption, and various configurations and models. Addition to historical environmental data, data from real-time weather observations from NOAA 308, Fleet Weather Center 314 data streams may be used to calculate fuel consumption based on resistance and environmental 334 factors exerted onto a vessel.

Primary operations data can be retrieved from MCS 318, vessel deck logs 320, vessel engineering logs 322, ICAS 326, and IPAR 324. An MCS-fitted vessel may require relatively few user input variables in order to execute the necessary calculations to determine propulsion-specific fuel consumption. For instance, MCS 318 computer files may be entered into a module in addition to user inputs for wind speed, wind direction, displacement, fouling estimates, and position, and by reading the MCS file, remaining inputs may be automated by the module. In some embodiments, the MCS can also provide the propulsion plant configuration and operation data that can be provided to the ICAS and used to calculate fuel consumed.

Data retrieved from vessel deck logs 320 and vessel engineering logs 322 may be correspond to vessel geographic positions and can be used to track the vessel's track (i.e., route) for a given voyage. For instance, in some embodiments, the longitude and latitude of a vessel may be manually collected from the vessel's deck logs 320, which, in some embodiments, report position three times daily (e.g., at 0800 hours, at 1200 hours, and at 2000 hours according to a 24-hour clock). In some embodiments, however, reliable longitudinal and latitudinal values may not be easily obtained. Accordingly, a vessel's position may be alternatively estimated based on the vessel's speed from a recorded shaft speed.

In some embodiments, Electric Plant Fuel Consumption 304 can represent the sum total load of equipment on a vessel. Sources of data for said equipment loads include but are not limited to ICAS 326, IPAR 324 summaries, electrical load analyses 328, OEM Gas Turbine Curves 330, and various energy baseline reports 332 and summaries. Other sources of data for real-time electrical plant fuel consumption information include, but are not limited to Global Energy Information System, Fleet Energy Conservation Dashboard, and Shipboard Energy Assessment System. In some embodiments, for each system reported in ICAS 326 and IPAR 324, the available data can be used to calculate a real-time service electrical load for systems where actual raw data reported is insufficient. In some embodiments, these electrical loads can be base values which generate initial starting points for the load each system or piece of equipment places on a vessel's generator, including but not limited to the corresponding fuel requirement. For instance, in some embodiments, air conditioning units can be calculated from ICAS 326 data inputs, controllable pitch propellers can be assigned base values of 25.8 kilowatts, fire pumps can be assigned base values of 60.133 kilowatts, fuel oil purifiers can be assigned base values of 31.4 kilowatts, reverse osmosis plants can be assigned base values of 10.85 kilowatts, and so on.

With available data from ICAS 326, machinery utilization and configuration assessments and projections may be generated specifically with respect to fuel consumption. Additionally, material condition and machinery performance data may be received from IPAR 324 sources to accurately calculate the impact of poor or fault conditions. Similarly, specific information relating to performance standards, such as data from electrical load analysis surveys 238, OEM Gas Turbine Curves 330, and energy baseline surveys 332 may be used to project the impact of fuel consumption for systems where fault conditions are unreported.

In some embodiments, once real-time electrical loads are ascertained for several pieces of equipment on the vessel, various models detailing equipment configurations for optimum fuel consumption can be provided. In some embodiments, six different configurations may yield optimal fuel consumption while maintaining a given level of equipment performance. For instance, a first configuration may determine that several pieces of equipment may be turned off, or reduced in performance in order to conserve energy consumption, and other pieces of equipment may remain at full power in order to compensate for the deactivated equipment. Such a configuration might result in a reduction of, for instance, five percent less fuel consumption than the current or baseline fuel consumption configuration. However, in a second configuration, due to varying material conditions, older or lower quality equipment may be shut down while newer or higher quality equipment may be set to full power. In a third configuration, equipment may be set to a particular schedule, in which some equipment is shut down at certain times of the day, and then set to operate at a given level of power at different times of day. In a fourth configuration, in light of certain factors (e.g., changes in total hull resistance, temperature, water temperature, etc.), the need for certain systems and pieces of equipment may vary at different times during a mission, and will be set to automatically reduce power consumption when real-time data reflects that such equipment and systems are operating at higher power levels than necessary at a given time. Other configurations may involve combinations of the features recited above, in addition to other features based on the data available from the methods provided in this disclosure.

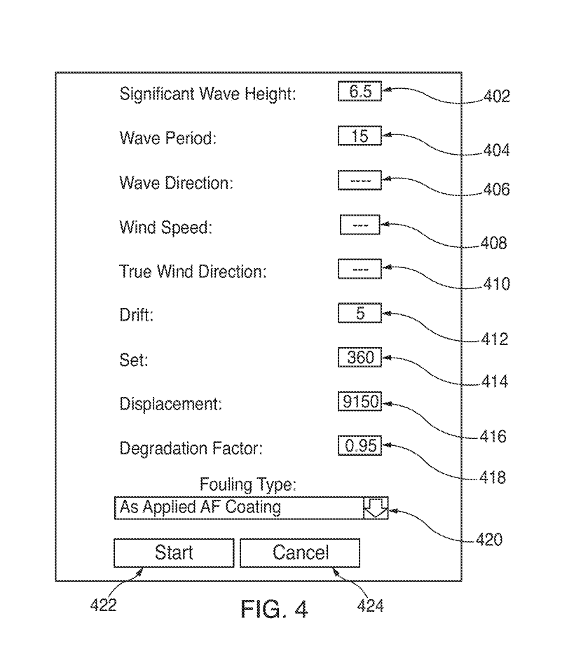

FIG. 4 is a schematic diagram of an input variable user-form for inputting values into a module for calculating fuel consumption in accordance with various embodiments of the disclosure. The interface includes window 400, a first input 402, and second input 404, and third input 406, a fourth input 408, a fifth input 410, a sixth input 412, a seventh input 414, an eighth input 416, a ninth input 418, a dropdown menu 420, a start option 422, and a cancellation option 424.

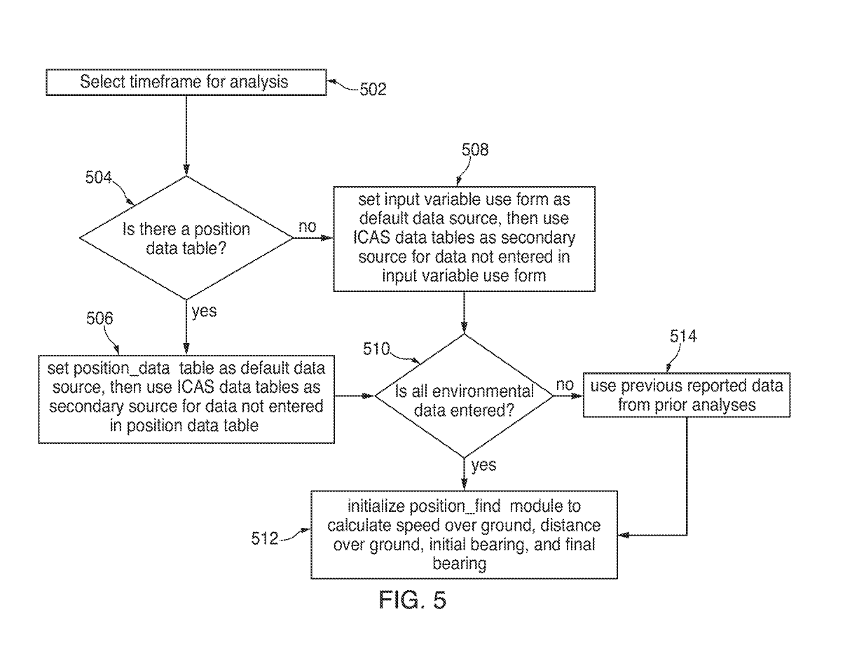

In some embodiments, a user inputs values into window 400. If the user's goal is to receive a projected fuel consumption for a given mission, then the user may input known or anticipated values. In another embodiment, if the user's goal is to receive real-time fuel consumption data, the user may input any values known to the user at the time. For instance, as shown in FIG. 4, the user is attempting to receive real time fuel consumption data during an operation. Not all information may be known to the user at that time. Accordingly, as shown with respect to the third input 406, fourth input 408, and fifth input 410, the user does not enter said unknown information. Accordingly, the remaining inputs are entered by the user due to the fact that such data is known at the time. In such some embodiments, the module may employ historical and/or real-time data from ICAS, MCS, various sensors installed on the vessel, or any other secondary source of data in order to make the necessary calculations in accordance with FIG. 5, which will be explained in further detail.

FIG. 5 is an illustrative flowchart of a process for prioritizing data sources in accordance with various embodiments.

At step 502, a timeframe can be selected for analysis. In some embodiments, the timeframe can be as little as a fraction of a second, or can be as long as years, depending on the information needed for analysis. As such, the timeframe may be selected by a user and the remainder of the process may proceed in accordance with that timeframe.

Step 504 involves determining whether a position data table is available. A position data table allows for the inclusion of position and environmental data at any time increment. A position data table can be used for the inclusion of ship's position and environmental data, if available. Latitude and longitude values can be manually entered. This data can then be converted to decimal format for distance analysis according to various methods, such as Great Circle Distance. Additionally, latitude and longitude can be converted to radians for analysis using methods such as the Spherical Law of Cosines. In some embodiments, the time increment between values on this table can be as short as a second and does not need to be at even intervals. In some embodiments, the position data table can be added and used to quantify important variables before any other data tables. Thus, process 500 can check if a position data table exists and set it as the default data source. In some embodiments, the position data table can be set as the first data source in the module if compiling the full set of available data.

Accordingly, if a position data table is available, then process 500 may proceed to step 506. At step 506, the position data worksheet may be set as the default data source and ICAS data tables can be used as secondary data sources for data not entered in the position data table.

If a position data table is not available, then process 500 might proceed to alternative step 508. Thus, if the position data table does not exist, an input variable use form such as that shown in FIG. 4 might be set as the default data source for the duration of the timeframe being analyzed. Then, as in step 506, ICAS data tables may be used as secondary sources of data, specifically for data not entered in the input variable use form.

After either step 506 or step 508 is completed, process 500 might proceed to step 510 to determine whether all environmental data is entered. At this step, all variables can be assessed to determine if there are any variables that have not been assigned values. In some embodiments, an assessment is made as to whether all variables necessary for the relevant calculations have been quantified to the extent that those calculations can be made.

If all environmental data has been entered, then process 500 might proceed to step 512. At step 512, a position find module can be initialized, which might calculate a vessel's speed over ground, distance over ground, initial bearing, and final bearing.

If not all environmental data has been entered, then process 500 might first proceed to step 514 prior to finally ending the process 500 at step 512. At step 514, previously reported data from prior reports and analyses are used to fill in any unquantified variables necessary to perform the necessary calculations. At that point, process 500 may proceed to step 512, and the position find module might be initialized.

In some embodiments, a position find module can match the vessel's position data and ICAS data based on time. It can then assign values (if any) for significant wave height, wave period, wind speed, wind direction, wave direction, set, and drift. The module may then calculate speed over ground, distance over ground, and initial and final bearing from position and time. In some embodiments, for gaps in environmental data, the previous forward value can be carried over until the next reported value occurs. In some embodiments, gaps in data can be filled by means of NOAA historical environmental data.

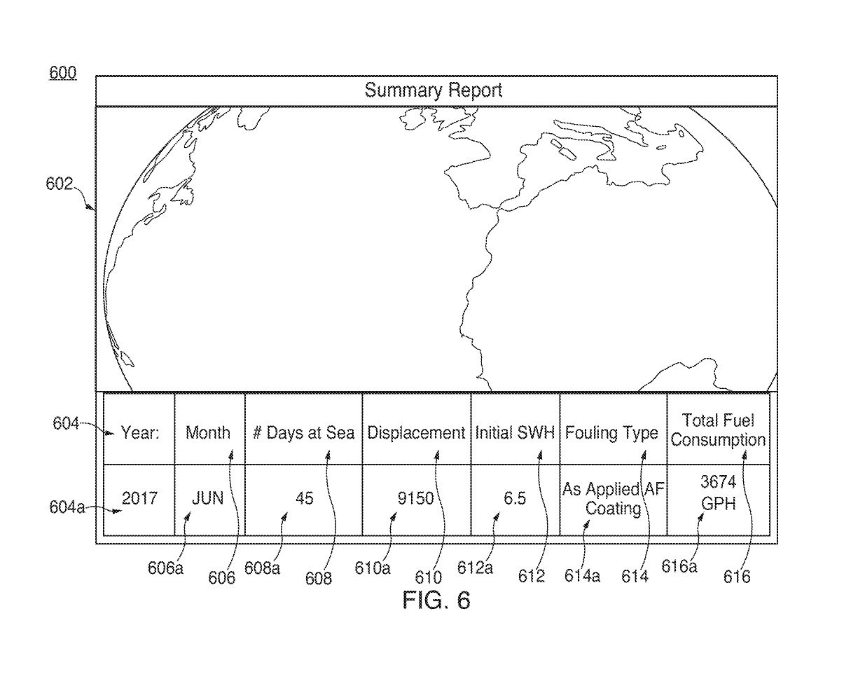

FIG. 6 is a graphical interface displaying an exemplary summary report in accordance with various embodiments. Summary report 600 includes a map 602, report of the year 604 and 604a, month 606 and 606a, total number of days at sea 608 and 608a, displacement 610 and 610, initial significant wave height 612 and 612a, fouling type 614 and 614a, and total fuel consumption 616 and 616a. Summary Report 600 may also report the total distance traveled through the water and over ground in map 602.

Summary Report 600 may include information regarding any number of factors. In some embodiments, Summary Report 600 is a model that indicates fuel consumption for a given projected configuration of the vessel. For instance, Summary Report 600 may include an itemized account of electric plant fuel consumption corresponding to each system or piece of equipment installed on a vessel, which can include data corresponding to hundreds of machines. Additionally, Summary Report 600 may provide links to more particularized information, such as a day-to-day breakdown of propulsion-specific fuel consumption for a given mission. Similarly, in some embodiments, Summary Report 600 may include the aforementioned itemized accounts and breakdowns with respect to a projected fuel consumption, real time fuel consumption, or post mission analysis. However, in the interest of simplicity and clarity, FIG. 6 only includes a Summary Report 600 that displays projected data corresponding to seven variables.

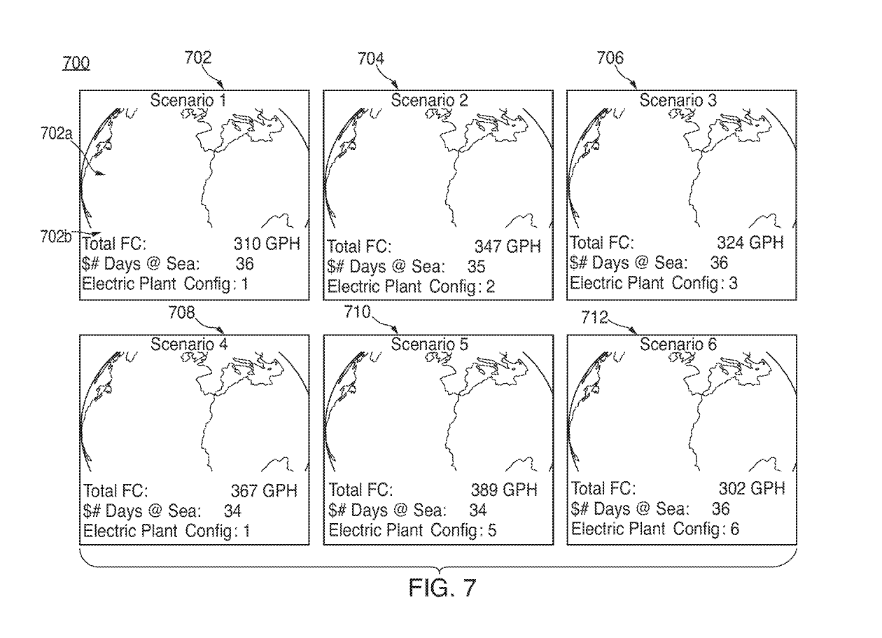

FIG. 7 is a graphical interface displaying a set of models in accordance with various embodiments. While the models in FIG. 7 are labeled therein as “scenarios,” it should be understood that the term “model” may be a scenario, configuration, or any other designated term. FIG. 7 includes interface 700, which includes model 1 702 (which itself includes map 702a and summary 702b) model 2 704, model 3 706, model 4 708, model 5 710, and model 6 712. Although only model 1 702 is labeled as having a map 702a and summary 702b, this was done so for the sake of simplicity and clarity of FIG. 7. As such, it should be understood that model 2 704, model 3 706, model 4 708, model 5 710, and model 6 712 each include a map and summary as well.

In some instances, a user might determine that the most fuel-efficient route is not the most time efficient model due to important deadlines, scheduling conflicts, needs for remaining available to make potential detours, etc. Accordingly, each model is a different model that includes different six graphical representations of six different routes, with each route operating under a different set of parameters.

In some embodiments, as noted above, various models for optimum electric plant fuel consumption can be generated. Thus, in some embodiments, a user may already select which model from which an electrical systems and equipment configuration can be based, and would like to select the most fuel efficient route in light of the selected electrical systems and equipment configuration. In another embodiment, a user has not yet selected an electrical systems and equipment configuration, and as such, the models displayed in interface 700 may not take into account any selected electrical systems and equipment configuration. In another embodiment, the option to select an electrical systems and equipment configuration can be provided after a model is selected from interface 700.

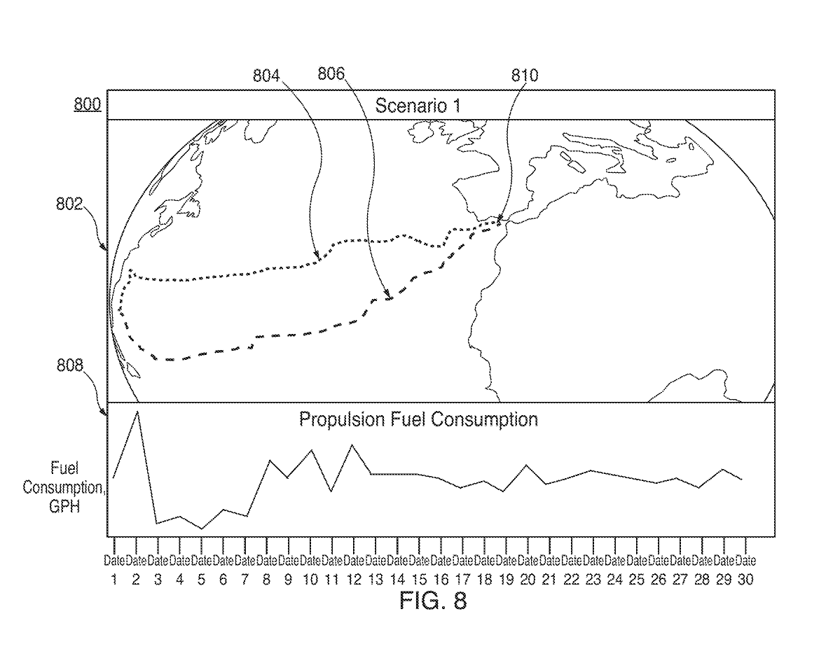

FIG. 8 is a graphical representation of a model in accordance with various embodiments. For illustrative purposes, model 800 depicted in FIG. 8 corresponds to model 1 702 of FIG. 7. Model 800 includes a map 802, a current course 804, an alternative course 806, a daily breakdown 808 of total fuel consumption and an incident 810. In the embodiment of FIG. 8, a vessel is conducting a mission in accordance with a projected model prior to commencement of the mission. Due to a series of factors requiring deviations from course, an operator of the vessel may wish to reassess the optimal configurations and course for minimizing fuel consumption. Accordingly, in the embodiment of FIG. 8, map 802 displays current course 806 as well as the projected route for current course 806. In some embodiments, a need to deviate from the projected course occurs at incident 810. At incident 810, a user might identify the need to deviate from the projected course and discover what alternative routes may be utilized. Under such circumstances, in addition to current course 804 and its projected route, map 802 displays alternative course 806, which discloses, for future purposes, an assessment of what the optimal route would have been given the current information, in addition to the optimal deviations for optimizing fuel consumption. Model 800 also displays a day-to-day breakdown 808 of fuel consumption for the projected alternative course 804. This breakdown 808 can begin at the date of the incident (e.g., “Date 1”) and continues to chart fuel consumption for each day until the anticipated last day of the mission/voyage (e.g., “Date 30”). All of this information may be stored as historical data at a server for the purposes of generating optimal courses for future missions for the vessel as well as for other vessels accessing the server.

In some embodiments, incident 810 can be an occurrence at which an automated system determines that an alternative fuel consumption model or model should be utilized. For instance, in an embodiment, a system can be continuously monitoring propulsion-specific fuel consumption and electric plant fuel consumption. In some embodiments, a system can detect at incident 810 that a real-time configuration of the vessel is consuming too much fuel, and that new models have been generated that would advantageously reduce fuel consumption. Thus, in some embodiments, the newly generated models may be displayed to a user such that the user can select a new configuration of the vessel's operations based on real-time data. In some embodiments, the vessel may automatically select a newly generated model as a new configuration of the vessel's operations as real-time data is received.

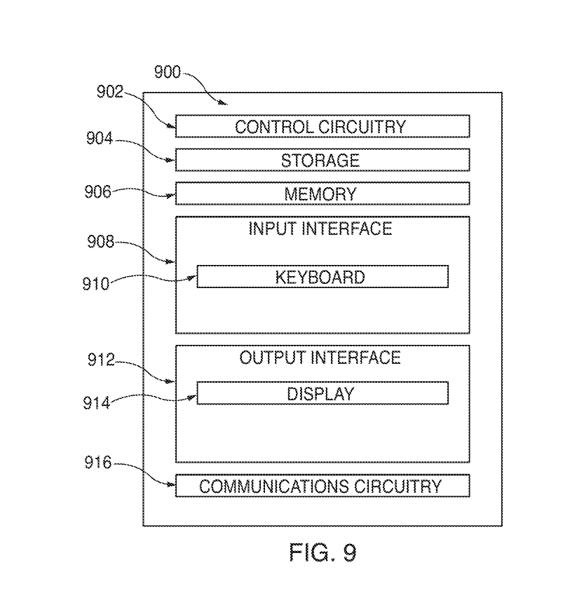

FIG. 9 is a block diagram of an illustrative user device in accordance with various embodiments. User device 900 can include control circuitry 902, storage 102, memory 104, input interface 908 (which includes keyboard 910), output interface 912 (which includes display 914), and communications circuitry 916.

Control circuitry 902 can include any processing circuitry or processor operative to control the operations and performance of user device 900. Storage 904 and memory 906 can be combined, and can include one or more storage mediums or memory components.

Input interface 908 can include any suitable mechanism or component capable of receiving inputs from a user. In some embodiments, input interface 908 can include a keyboard 910, a camera, a microphone, a controller, a joystick, a mouse, or any other suitable mechanism for receiving user inputs. Input interface 908 can also include circuitry configured to at least one of convert, encode, and decode analog signals and other signals into digital code. One or more mechanisms or components in input interface 908 can also be electrically coupled with control circuitry 902, storage 904, memory 906, communications circuitry 916, any other suitable components within device 900, or any combination thereof.

Output interface 912 can include any suitable mechanism or component capable of providing outputs to a user. In some embodiments, output interface 912 can include a display 914. Output interface 912 can also include circuitry configured to convert, encode, and/or decode digital data into analog signals and other signals. For example, output interface 912 can include circuitry configured to convert digital signals for use by an external display. Any mechanism or component in output interface 914 can be electrically coupled with control circuitry 902, storage 904, memory 906, communications circuitry 916, any other suitable components within user device 900, or any combination thereof.

Display 914 can include any suitable mechanism capable of displaying visual content (e.g., images or indicators that represent data). For example, display 914 can include a thin-film transistor liquid crystal display, an organic liquid crystal display, a plasma display, a surface-conduction electron-emitter display, organic light emitting diode display, or any other suitable type of display. Display 914 can be electrically coupled with control circuitry 902, storage 904, memory 906, input circuitry 908, other components of output circuitry 912, communications circuitry 916, any other suitable components within user device 900, or any combination thereof. Display 914 can display images stored in user device 900 (e.g., stored in storage 904 and/or memory 906) or images received by device 900 (e.g., images received using communications circuitry 916).

Communications circuitry 916 can include any suitable communications circuitry capable of connecting to a communications network, and transmitting and receiving communications (e.g., voice or data) to and from other devices within the communications network. Communications circuitry 916 can be configured to interface with the communications network using any suitable communications protocol. For example, communications circuitry 916 employ Wi-Fi (e.g., an 802.11 protocol), Bluetooth®, radio frequency systems (e.g., 900 MHz, 1.4 GHz, and 5.6 GHz communications systems), cellular networks (e.g., GSM, AMPS, GPRS, CDMA, EV-DO, EDGE, 3GSM, DECT, IS-136/TDMA, iDen, LTE, or any other suitable cellular network or protocol), infrared, TCP/IP (e.g., any of the protocols used in each of the TCP/IP layers), HTTP, BitTorrent, FTP, RTP, RTSP, SSH, Voice over IP, any other communications protocol, or any combination thereof. In some embodiments, communications circuitry 916 can be configured to provide wired communications paths for user device 900.

The various embodiments of the disclosure may be implemented by software, but can also be implemented in hardware or a combination of hardware and software. The disclosure can also be embodied as computer readable code on a computer readable medium. The computer readable medium can be any data storage device that can store data, which can thereafter be read by a computer system. Examples of a computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The above-described embodiments of the disclosure are presented for purposes of illustration and not of limitation.

What is claimed is:

1. A method for determining energy consumption of a waterborne vessel during an operational period, comprising:
determining a total resistance applied to the vessel;
determining a total horsepower required for the vessel to overcome the total resistance;
receiving a plurality of inputs corresponding to a condition of the vessel;
determining propulsion-specific fuel consumption based on the determined total resistance, determined total horsepower required, and the received condition inputs;
determining electric plant fuel consumption;
calculating a total required fuel based on the sum of the propulsion-specific fuel consumption and electric plant fuel consumption;
generating a plurality of projected propulsion-specific fuel consumption models;
generating a plurality of projected electric plant fuel consumption models; and
generating a fuel consumption optimizing configuration, comprising:
a projected propulsion-specific fuel consumption model of the plurality of projected propulsion-specific fuel consumption models; and
a projected electric plant fuel consumption model of the plurality of electric plant fuel consumption models.

2. The method of claim 1, further comprising automatically configuring the vessel to the fuel consumption optimizing configuration.

3. The method of claim 1, further comprising, after generating the fuel consumption optimizing configuration, continuously monitoring electrical plant fuel consumption.

4. The method of claim 3, further comprising, after generating the fuel consumption optimizing configuration, continuously monitoring propulsion-specific fuel consumption.

5. The method of claim 4, wherein monitoring propulsion-specific fuel consumption further comprises:
determining a total real-time resistance applied to the vessel;
determining a total real-time horsepower required for the vessel to overcome the total real-time resistance;
receiving a plurality of real-time inputs corresponding to a condition of the vessel; and
determining real-time propulsion-specific fuel consumption based on the determined total real-time resistance, determined total real-time horsepower required, and the received real-time condition inputs.

6. The method of claim 1, further comprising:
generating a real-time fuel consumption optimizing configuration; and
automatically configuring the vessel to the real-time fuel consumption optimizing configuration.

7. The method of claim 1, further comprising displaying, on a user interface, the fuel optimizing configuration.

8. The method of claim 1, wherein the vessel comprises a plurality of machines, and determining propulsion-specific fuel consumption comprises determining a fuel consumption for each machine of the plurality of machines.

9. The method of claim 1, wherein determining electric plant fuel consumption comprises determining a fuel consumption for each device of a plurality of devices electrically coupled to the vessel.

10. A method for projecting fuel consumption for a waterborne vessel, comprising:
receiving, at a user device, an primary input of data corresponding to at least one of total resistance acting upon the vessel and electric plant fuel consumption;
receiving, from memory, a first set of historical data corresponding to resistance acting upon the vessel;
receiving, from memory, a second set of historical data corresponding to electric plant fuel consumption;
determining a propulsion-specific fuel consumption corresponding to the total resistance, wherein the total resistance comprises the input of data and the first set of historical data; and
calculating, in response to determining the total horsepower, a total fuel consumption based on:
a total electric plant fuel consumption comprising the primary input of data and the second set of historical data; and
the propulsion-specific fuel consumption.

11. The method of claim 10, further comprising:
recording a third set of historical data corresponding to the vessel's actual fuel consumption; and
storing the third set of historical data in memory.

12. The method of claim 11, wherein the first set of historical data corresponds to a first data curve and the second set of historical data corresponds to a second data curve.

13. The method of claim 12, further comprising plotting the third set of historical data along at least one of the first data curve and the second data curve.

14. The method of claim 10, wherein the primary input of data comprises a predefined data table.

15. The method of claim 10, wherein the primary input of data is provided by a user input.

16. The method of claim 10, further comprising determining, in response to receiving the second set of historical data, a plurality of variables necessary to calculate the propulsion-specific fuel consumption.

17. The method of claim 16, wherein determining the set of variables comprises determining that the plurality of variables consists of the primary input of data, the first set of data, and the second set of data.

18. The method of claim 16, wherein determining the plurality of variables comprises determining that a variable of the plurality of variables is unknown; and
assigning a quantity to the variable based on a fourth set of historical data.

19. A device, comprising:
storage;
memory;
an input interface operable to:
receive a plurality of inputs corresponding to a condition of a vessel;
an output interface;
communications circuitry; and
control circuitry operable to:
determine a total resistance applied to a vessel;
determine a total horsepower required for the vessel to overcome the total resistance;
determine propulsion-specific fuel consumption based on the determined total resistance, determined total horsepower required, and the received condition inputs;
determine electric plant fuel consumption;
calculate a total required fuel based on the sum of the propulsion-specific fuel consumption and electric plant fuel consumption;
generate a plurality of projected propulsion-specific fuel consumption models;
generate a plurality of projected electric plant fuel consumption models; and
generate a fuel consumption optimizing configuration, comprising:
a projected propulsion-specific fuel consumption model of the plurality of projected propulsion-specific fuel consumption models; and
a projected electric plant fuel consumption model of the plurality of electric plant fuel consumption models.

20. A non-transitory computer readable medium containing instructions that, when executed by at least one processor of a computing device, cause the computing device to:
determine a total resistance applied to a vessel;
determine a total horsepower required for the vessel to overcome the total resistance;
receive a plurality of inputs corresponding to a condition of the vessel;
determine propulsion-specific fuel consumption based on the determined total resistance, determined total horsepower required, and the received condition inputs;
determine electric plant fuel consumption;
calculate a total required fuel based on the sum of the propulsion-specific fuel consumption and electric plant fuel consumption;
generate a plurality of projected propulsion-specific fuel consumption models;
generate a plurality of projected electric plant fuel consumption models; and
generate a fuel consumption optimizing configuration, comprising:
a projected propulsion-specific fuel consumption model of the plurality of projected propulsion-specific fuel consumption models; and
a projected electric plant fuel consumption model of the plurality of electric plant fuel consumption models.
